(19) United States
(12) Patent Application Publication
(10) Pub. No.: US 2026/0030301 A1
(43) Pub. Date: Jan. 29, 2026

(54) DOCUMENT AND DATA SEARCH AND ASSURANCE SYSTEM AND METHOD USING DIGITAL FINGERPRINTING

(71) Applicants: Damien Georges, Warwick, NY (US); Christophe Person, Houston, TX (US)

(72) Inventors: Damien Georges, Warwick, NY (US); Christophe Person, Houston, TX (US)

(21) Appl. No.: 18/962,546

(22) Filed: Nov. 27, 2024

Related U.S. Application Data
(60) Provisional application No. 63/675,775, filed on Jul. 26, 2024.

(51) Int. Cl. G06F 16/906; G06F 16/93

(52) U.S. Cl. CPC G06F 16/906; G06F 16/137; G06F 16/93; G06F 16/152; G06F 21/64

(57) ABSTRACT

A method for document management includes receiving, in a document management system, a document. The document is not permanently stored in the document management system. The method includes processing the document to identify metadata and contents of the document. The method also includes generating a digital fingerprint of the document based on the metadata and contents of the document. Further, the method includes storing the digital fingerprint in the document management system. The method includes removing the document from the document management system. Additionally, the method includes classifying the document based on the digital fingerprint and the metadata for the document.

### CROSS-REFERENCE TO RELATED APPLICATIONS

This application claims the benefit of priority of U.S. provisional application No. 63/675,775, filed Jul. 26, 2024, titled “DOCUMENT AND DATA SEARCH AND ASSURANCE SYSTEM AND METHOD USING DIGITAL FINGERPRINTING,” the entire contents of which are herein incorporated by reference.

### FIELD

The present disclosure relates to document management systems, and more particularly, to a document management system with advanced searching functionality and assurance utilizing digital fingerprinting.

### BACKGROUND

Maintaining document compliance and integrity is a challenge across industries due to the limitations of current digital and physical document storage systems. Current systems often fail to provide sufficient security, risking unauthorized access and data breaches. Furthermore, the current systems generally involve complex, resource-intensive processes that are prone to human error and non-compliance with stringent regulatory standards. Attempts to automate document management typically rely on artificial intelligence, or other algorithms, which introduce errors due to algorithmic biases or inaccuracies in data interpretation.

As can be seen, there is a need for an improved document management system configured to accurately and securely manage, cluster, classify, and retrieve documents without the need for physical storage or reliance on traditional AI methodologies, thereby mitigating risks associated with data security and regulatory non-compliance.

### SUMMARY

In one aspect of the present disclosure, a method for document management includes receiving, in a document management system, a document. The document is not permanently stored in the document management system. The method includes processing the document to identify metadata and contents of the document. The method also includes generating a digital fingerprint of the document based on the metadata and contents of the document. Further, the method includes storing the digital fingerprint in the document management system. The method includes removing the document from the document management system. Additionally, the method includes classifying the document based on the digital fingerprint and the metadata for the document.

In another aspect of the present disclosure, a computer-readable medium stores instructions for causing a processing device to perform a method for document management. The method includes receiving, in a document management system, a document. The document is not permanently stored in the document management system. The method includes processing the document to identify metadata and contents of the document. The method also includes generating a digital fingerprint of the document based on the metadata and contents of the document. Further, the method includes storing the digital fingerprint in the document management system. The method includes removing the document from the document management system. Additionally, the method includes classifying the document based on the digital fingerprint and the metadata for the document.

### BRIEF DESCRIPTION OF THE DRAWINGS

FIG. 1 is a block diagram of an embodiment of a document management system, according to aspects of the present disclosure;

FIG. 2 is a flowchart of an embodiment of a method of using a document management system, according to aspects of the present disclosure;

FIG. 3 is a diagram of modules of the document management system of FIG. 1, according to aspects of the present disclosure; and

FIGS. 4-6 are process diagrams of fingerprint-matching processes performed by the document management system of FIG. 1, according to aspects of the present disclosure.

### DETAILED DESCRIPTION OF THE DISCLOSURE

The following detailed description is of the best currently contemplated modes of carrying out exemplary embodiments of the disclosure. The description is not to be taken in a limiting sense but is made merely for the purpose of illustrating the general principles of the disclosure, since the scope of the disclosure is best defined by the appended claims.

Current document management systems suffer from deficiencies associated with storage infrastructure, algorithm usage, and human intervention. These systems often fail to provide sufficient security, risking unauthorized access and data breaches. For example, current document management systems typically rely on storing actual document content or using artificial intelligence (AI) driven methods, which can lead to security vulnerabilities, inaccuracies, and difficulties in maintaining compliance with regulatory standards. Additionally, these systems often require extensive storage infrastructure and are prone to errors due to algorithmic biases. These systems do not operate effectively because they rely on storing sensitive document content, which increases the risk of data breaches, and they often depend on AI-driven methods that can introduce inaccuracies and biases, compromising document integrity and regulatory compliance.

Broadly, an embodiment of the present disclosure describes a document management system that employs a unique combination of technologies that eliminate the need for physical document storage and reduce reliance on traditional algorithmic methodologies. The document management system utilizes advanced similarity search algorithms, optimized to analyze and manage digital documents. The document management system creates digital signatures for each document in the document management system, which are then used to cluster/group, classify, validate, and retrieve documents rapidly and accurately, in a single search pass. The document management system operates without persistently storing any document or its data, ensuring high security and compliance while maintaining nearly perfect accuracy in document retrieval and analytics.

Advantageously, the document management system enhances data security by minimizing the risk of breaches and improves operational efficiency by automating document handling processes, thereby maintaining continuous compliance with regulatory standards. Moreover, the document management system addresses the problem of securely managing, classifying, and retrieving large volumes of documents with high accuracy while avoiding the risks associated with storing sensitive document content.

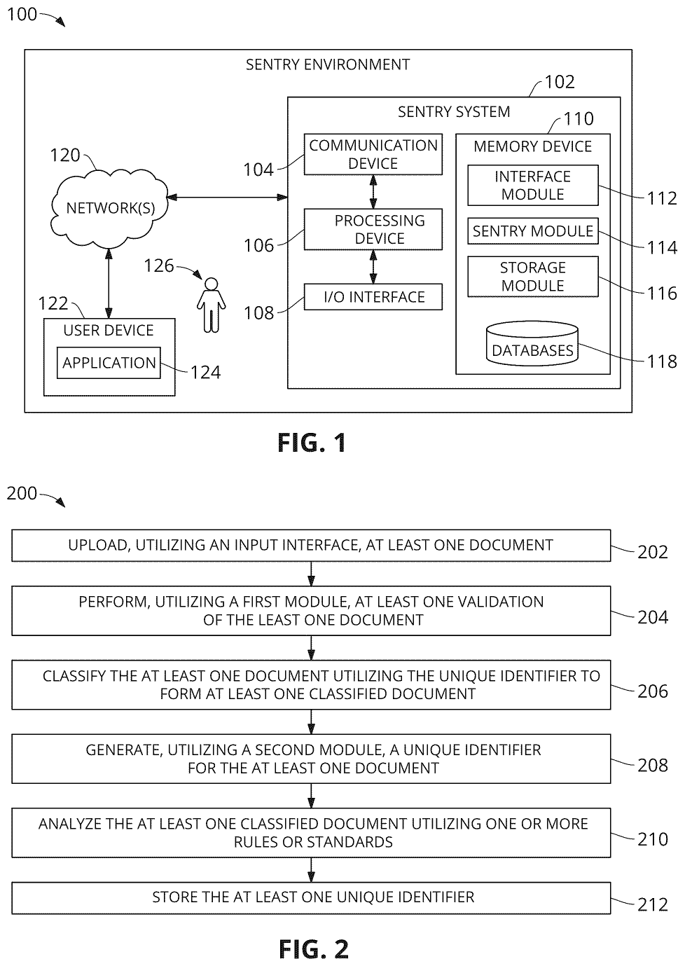

Referring now to FIGS. 1-6, FIG. 1 illustrates an embodiment of a sentry environment 100 including a document management system, hereinafter sentry system 102, according to aspects of the present disclosure. While FIG. 1 illustrates various components of the sentry system 102, additional components can be added, and existing components can be removed.

In embodiments, the sentry system 102 utilizes a unique digital fingerprinting technology that generates a distinct identifier for each document, eliminating the need to store the actual document content. This approach ensures accurate classification and retrieval of documents while maintaining high levels of security and compliance with regulatory standards. By focusing on the digital fingerprint rather than the document itself, the system provides a secure and efficient method for managing large volumes of documents across various industries. By utilizing a unique digital fingerprinting method, the sentry system 102 identifies and classifies documents without storing the actual document content, thereby enhancing security and accuracy beyond what current systems provide. This approach reduces reliance on traditional storage and AI methods, offering a novel solution for secure and compliant document management.

In embodiments, the sentry system 102 provides the following functionality, features, and processes:
1. Sentry's Search Versatility

The sentry system 102 provides multi-directional searches, enabling document-to-document, document-to-data, document-to-document types, and data row-to-document associations. This feature enhances the retrieval and classification capabilities beyond traditional systems.
2. Automated Grouping and Clustering

The sentry system 102 clusters similar documents and data rows based on fingerprint similarity and statistical methodologies. This allows the identification of high-priority groups, labeled or unlabeled, streamlining compliance workflows and document classification.
3. Custom Digital Fingerprints

Fingerprints are tailored using token weights, specific keywords, and heuristic enhancements. This ensures precision and adaptability for industry-specific applications and compliance requirements.
4. Fingerprint Reusability

Fingerprints are reusable across various documents, document types and data rows, allowing seamless linking and validation. This feature eliminates redundant processing and supports efficient compliance management.
5. Scalability and Efficiency

The sentry system 102 employs a lightweight fingerprint architecture that supports the processing of large datasets with minimal resource usage. The modular design enables integration across platforms through API-driven architecture.
6. Security-Driven Design

The sentry system 102 operates without storing document content. Fingerprints are derived deterministically, ensuring high levels of data privacy and minimizing the risks of breaches or unauthorized access.
7. Proxy Role and Virtual Document Management

The sentry system 102 functions as a proxy for traditional document management systems, leveraging API-driven integrations. Its virtual document management approach enables secure compliance monitoring without document storage.
8. Advanced Reporting Tools

The sentry system 102 generates detailed compliance and integrity reports derived from fingerprints. These reports support audits and regulatory reviews, reducing manual intervention and ensuring accuracy.
9. Differentiation from AI-Driven Systems

Unlike traditional AI-driven systems that rely on model training and introduce biases, the sentry system 102 utilizes deterministic fingerprinting to ensure accurate, unbiased processing. This provides a robust alternative to error-prone AI-based methods.

As illustrated in FIG. 1, the sentry system 102 includes one or more processing devices, herein processing device 104, coupled to a communication device 106. The processing device 104 is also coupled to a memory device 108, and an input/output (“I/O”) interface 110. In embodiments, the communication device 106 enables the sentry system 102 to communicate with other devices and systems via one or more networks 116. The sentry system 102 can communicate with a user device 120 via the network 116. A user 122 can utilize the user device 120 to communicate with the sentry system 102. The user device 120 can include one or more electronic devices such as a laptop computer, a desktop computer, a tablet computer, a smartphone, a thin client, a smart appliance, and the like. While FIG. 1 illustrates one user device 120, the sentry environment 100 can include multiple user devices operated by the user 122 or operated by other users.

According to the aspects of the present disclosure, the sentry system 102 enables the user 122, operating a copy of an application 124 executing on the user device 120, to communicate with the sentry system 102 and leverage the service provided by the sentry system 102. The sentry system 102 is configured to utilize digital fingerprinting of documents for classification, identification, and management of documents without the need to store the documents physically or digitally. In embodiments, the application 124 can be a specifically designed application that operates with the sentry system 102 to perform the processes and methods described herein. In embodiments, the application 124 can be a third-party application, such as a web browser, word processing application, spreadsheet application etc., that communicates with the sentry system 102 to perform the processes and methods described herein. The memory device 108 can also include one or more databases 114 that store information and data associated with the process and methods described below in further detail.

To perform the process described herein, the sentry system 102 can store and execute an interface module 140, a sentry module 142, and a storage module 144 to perform the processes and methods described herein. The interface module 140, the sentry module 142, and the storage module 144 can be stored in the memory device 108. The interface module 140, the sentry module 142, and the storage module 144 can include the necessary logic, instructions, and/or programming to perform the processes and methods described in further detail below. The interface module 140, the sentry module 142, and the storage module 144 can be written in any programming language.

According to aspects of the present disclosure, the sentry system 102, for example, via the interface module 140, provides unique interfaces that allow the user 122 to manage documents. The sentry system 102, for example, via the Interface module 140, provides interfaces for document input, document processing, fingerprint generation, document classification, data analysis, document validation, etc. For example, a compliance monitoring dashboard can be provided which can aggregate data from the Sentry system 102 and provides real-time visibility into compliance status, alerting users to any issues or discrepancies that need attention. Additionally, a reporting tool can leverage information from the sentry module 142 and generate comprehensive reports that detail the compliance status, document integrity, and other critical metrics. The interface module 140 operates to generate and provide graphical user interfaces (GUIs) to the application 122, for example, menus, widgets, text, images, fields, etc., as described below in further detail. The GUIs generated by the interface module 140 can be interactive.

The sentry system 102, for example, via the interface module 140, also provides one or more application programming interfaces (APIs) that provide connection points for one or more applications, e.g., the application 124. Integration with external applications and business systems is facilitated by the APIs, which allows the sentry system 102 to seamlessly connect with other platforms, ensuring smooth operation within existing workflows.

In embodiments, the interface module 140 can implement voice control aspects into the interfaces provided. For example, the user can navigate the interfaces of the sentry system 102 using the audio input device of the user device 120. The interface module 140 can implement one or more chat-bots to deliver conversational input and output to a user.

According to aspects of the present disclosure, the sentry system 102, for example, via the sentry module 142, through a plurality of submodules provides functionality to manage documents in sentry system 102. In embodiments, sentry module 142 can include a plurality of submodules such as an input interface, document processing engine, digital fingerprint generator, document classification engine, data analysis module, and document validation module. Additionally, a plurality of optional submodules can be included in sentry system 102 such as an integration AP, security module, machine learning module, and collaboration tools module.

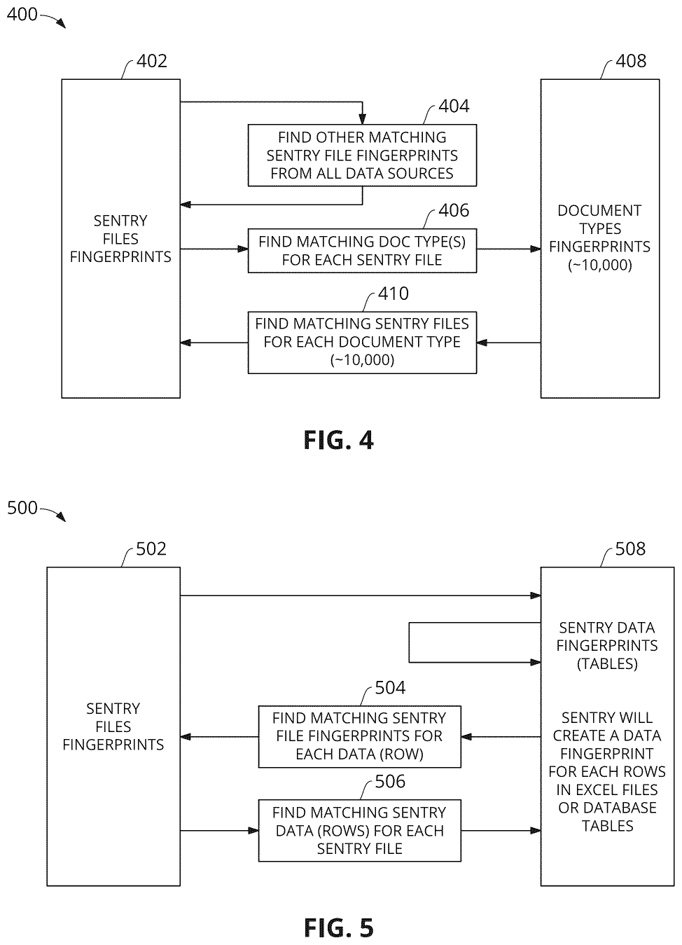

As illustrated in FIG. 3, the plurality of sub-modules of sentry module 142. An input interface module can provide functionality (sentry connect 320) to allow documents to be uploaded into sentry system 102 in a secure manner. The source of the documents can be any type of application and system that is within an environment 322 of an entity, for example, IT, marketing, logistics, HR, assents, operations, finance, strategy, compliance, sales, legal, front office, etc.

In embodiments, input interface can interface with peripheral devices such as scanners, cameras, etc., to digitize physical documents, and can provide interfaces for a user to upload digital and/or digitized documents into sentry system 102, thereby starting document assurance processes. In embodiments, input interface can provide support for a plurality of document formats to be uploaded into Sentry system 102.

A data processing engine can provide functionality (sentry source file registration and processing 318) to ensure documents uploaded to sentry system 102 meet basic format and integrity standards. In embodiments, a data processing engine can include a plurality of logic checks, or functions, to determine document integrity and format validation, thereby ensuring each document is suitable for processing by Sentry system 102. Based on the type of document and its characteristics, the system uses if-then logic to decide whether to apply virus scanning, OCR, stopword removal, confidential token detection (ex: social security numbers, credit card numbers, banking information, confidential references, GDPR/APRA, . . . ), or other preprocessing steps.

A document fingerprint generator can provide functionality for creating unique identifiers for each document in the sentry system 102. In embodiments, the document fingerprint generator functions by extracting key features metadata).
Document Metadata: Titles, dates, authors, and tags are also considered during fingerprint generation.

Prior to generating the digital fingerprint, the sentry system 102 can perform preprocessing. For example, the preprocessing can include the following:
Text Extraction: Content from documents is read into memory without being stored. OCR is used for image-based documents.
Cleaning and Normalization:
Removal of common stopwords (e.g., “the,” “and”) from a document, akin to creating a genetic profile of the document, and utilizes those features in the creation of a unique digital fingerprint for the document. In embodiments, the content of each document is not saved or stored, thereby improving security and privacy for sentry system 102.

In embodiments, the sentry system 102 can utilize the following exemplary data to generate the digital fingerprints:
Documents: Can include PDFs, Word files, scanned images, spreadsheets, database rows, website pages, software development files, and more.
Data Sources: Structured (e.g., tabular data like rows in CSV, API responses, or database tables) and unstructured data in Documents (e.g., document text, Document Metadata: Titles, dates, authors, and tags are also considered during fingerprint generation.

Prior to generating the digital fingerprint, the sentry system 102 can perform preprocessing. For example, the preprocessing can include the following:
Text Extraction: Content from documents is read into memory without being stored. OCR is used for image-based documents.
Cleaning and Normalization:
Removal of common stopwords (e.g., “the,” “and”).
Tokenization: Splitting text into meaningful segments or tokens.
Confidential Tokens detections: special tokens are added to identify specific confidential content from document (social security numbers, credit card numbers, banking information, etc.) (e.g. “found” ‘US Social Security Number’ token)
Format Standardization: Ensures uniformity in text encoding and data organization for further processing.

To generate the digital fingerprint, the sentry system 102 can perform the following exemplary processes:
Feature Extraction:
Statistical representation of tokens, such as word frequency counts or importance weighting.
Metadata analysis, such as document type, structure, and associated tags.
Algorithms Used:
CountVectorizer: Counts occurrences of tokens in the document, forming a vector-based representation.
TfidfVectorizer (Term Frequency-Inverse Document Frequency):
Measures the importance of words in the context of the document and across all documents in the dataset.
Balances common and rare tokens to create a distinctive representation.
Embedding Enhancements:
Heuristics tailored to specific document types or industries.
Custom token weighting and relevance scores for domain-specific contexts.

The sentry system 102 can generate a digital fingerprint that has the following exemplary structure:
Digital Representation:
A fingerprint is a compact numerical vector representing the document's unique features.
Includes both content-based features (from text) and structural/contextual metadata.
Hierarchical Composition:
At the document level: Summarizes overall document features.
At the data row level: Represents unique rows in structured datasets.
Combined fingerprints can link documents to their data elements.

Once the digital fingerprint is generated, the sentry system 102 can store the digital fingerprint and utilize the digital fingerprint in various application. Fingerprints are stored securely without retaining the actual content of the documents or rows. Standard md5 (Message-Digest Algorithm 5) is used to identify and manage exact, duplicate copies of already-existing documents in sentry system 102, avoiding the need to create unnecessary fingerprints and search duplicate fingerprints. Fingerprints are used to perform similarity searches between documents, validate document integrity, and cross-reference data across multiple sources. Cosine similarity and other mathematical distance metrics are applied to determine matches or relationships.

Accordingly, sentry system 102 utilizes tailored embeddings to ensure fingerprints are unique and contextually relevant. Efficient algorithms allow fingerprints to be computed and stored for large datasets without compromising performance. Actual document content is never stored, reducing data security risks.

A document classification engine can provide functionality (sentry fingerprint search 316) to categorize documents into predefined classes based on their unique fingerprint. In embodiments, document classification can be performed based on patterns and metadata extracted during the fingerprinting process, aligning documents with specific compliance requirements or organizational needs. In embodiments, the document classification engine uses a digital fingerprint to categorize the document into a specific class based on predefined criteria. This might involve identifying the document type (e.g., legal contracts, financial statements, government forms) and associating it with relevant compliance requirements. For example, as in FIG. 3, the categories can include by data list 302, by document type 304, by team or role 306, by status 308, or by dates 310.

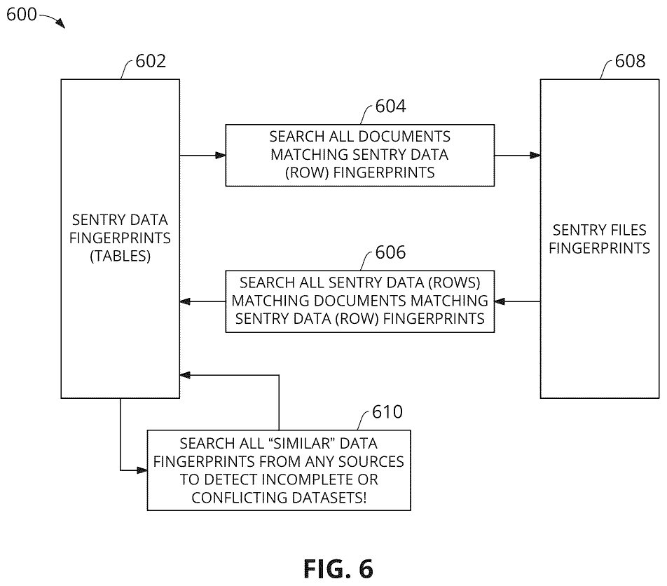

FIGS. 4-6 illustrate examples of the processes of the sentry system 102 that demonstrate the versatility and accuracy of digital fingerprinting. As illustrated, the multi-directional matching and grouping capabilities ensure precise search results, comprehensive compliance validation, and efficient document/data organization.

FIG. 4 illustrates a process for multi-level fingerprinting and matching. As illustrated, the sentry system 102 identifies matches between various entities (documents, document types, data rows). The sentry system 102 generates unique fingerprints for each document uploaded into the system. Fingerprints are cross-referenced to identify relevant document types. For structured data (e.g., spreadsheets, database table rows), fingerprints are created for each row and matched to document fingerprints. Documents can be searched based on data rows and vice versa, ensuring complete traceability and relevance.

FIG. 5 illustrates a process for fingerprint grouping and validation. As illustrated, the sentry system 102 groups similar documents or data and validates their relationships. Documents and data are clustered based on fingerprint similarity. Larger clusters typically indicate widely shared attributes or formats, which might need further validation or assignment to a “Trusted Document Type.” Groups are categorized by their proximity to predefined criteria, such as compliance or metadata attributes. The sentry system 102 uses rules and standards to ensure that grouped entities meet predefined compliance metrics, flagging discrepancies for further review.

FIG. 6 illustrates a process for comprehensive search and data integrity checks. The sentry system 102 employs search and assurance mechanisms operate. In a 360° search, the sentry system 102 can query across all document types, rows, and metadata to detect all historical versions for a given document, missing information, or inconsistencies. Through fingerprint comparison, the sentry system 102 identifies incomplete or conflicting datasets, ensuring integrity. The sentry system 102 aligns fingerprints across multiple data repositories, enabling audits of consistency and compliance across disparate systems.

A data analysis module can provide functionality (sentry document assurance 314) to analyze documents to ensure accuracy and compliance with regulatory standards. In embodiments, data analysis module can employ similarity search algorithms and other optimized statistical methods to assess and compare document features, ensuring that each document's content is consistent with its classification. A document validation module can provide functionality to validate documents against compliance and standards criteria. In embodiments, logical operators, such as if-then logic can be used to determine if a document adheres to required standards. In embodiments, the document validation module can flag any discrepancies discovered for further review, and/or remedial action.

Referring now to optional sub-modules of sentry module 142, an integration API can be provided to allow sentry environment 100 to integrate with existing business systems, such as enterprise resource planning systems, and document management platforms, thereby making Environment 100 more versatile and user-friendly. A security module can provide functionality to add robust encryption and/or multifactor authentication. A machine learning module can provide functionality to automate more complex classification and analysis tasks, thereby improving the system's efficiency and accuracy over time. Finally, a real-time collaboration tools module can be provided to functionality for real-time collaboration between users. In embodiments, real-time collaboration functionality can allow users to collaborate, in real-time, on document validation and compliance tasks. In embodiment, document exchange functionality (sentry document exchange hub 312) can be provided. The document exchange hub can hash and manage digital fingerprints of trusted documents across external sources outside the environment 322. Trusted document types are central to Sentry's compliance assurance framework, ensuring document authenticity and integrity.

Returning to FIG. 1, the processing device 104, the communication device 106, the memory device 108, and the I/O interface 110 can be interconnected via a system bus. The system bus can be and/or include a control bus, a data bus, and address bus, and so forth. The processing device 104 can be and/or include a processor, a microprocessor, a computer processing unit (“CPU”), a graphics processing unit (“GPU”), a neural processing unit, a physics processing unit, a digital signal processor, an image signal processor, a synergistic processing element, a field-programmable gate array (“FPGA”), a sound chip, a multi-core processor, and so forth. As used herein, “processor,” “processing component,” “processing device,” and/or “processing unit” can be used generically to refer to any or all of the aforementioned specific devices, elements, and/or features of the processing device. While FIG. 1 illustrates a single processing device 104, the sentry system 102 can include multiple processing devices 104, whether the same type or different types.

The memory device 108 can be and/or include computerized storage medium capable of storing electronic data temporarily, semi-permanently, or permanently. The memory device 108 can be or include a computer processing unit register, a cache memory, a magnetic disk, an optical disk, a solid-state drive, and so forth. The memory device can be and/or include random access memory (“RAM”), read-only memory (“ROM”), static RAM, dynamic RAM, masked ROM, programmable ROM, erasable and programmable ROM, electrically erasable and programmable ROM, and so forth. As used herein, “memory,” “memory component,” “memory device,” and/or “memory unit” can be used generically to refer to any or all of the aforementioned specific devices, elements, and/or features of the memory device. While FIG. 1 illustrates a single memory device 108, the sentry system 102 can include multiple memory devices 108, whether the same type or different types.

The communication device 106 enables the sentry system 102 to communicate with other devices and systems. The communication device 106 can include, for example, a networking chip, one or more antennas, and/or one or more communication ports. The communication device 106 can generate radio frequency (RF) signals and transmit the RF signals via one or more of the antennas. The communication device 104 can generate electronic signals and transmit the RF signals via one or more of the communication ports. The communication device 106 can receive the RF signals from one or more of the communication ports. The electronic signals can be transmitted to and/or from a communication hardline by the communication ports. The communication device 106 can generate optical signals and transmit the optical signals to one or more of the communication ports. The communication device 106 can receive the optical signals and/or can generate one or more digital signals based on the optical signals. The optical signals can be transmitted to and/or received from a communication hardline by the communication port, and/or the optical signals can be transmitted and/or received across open space by the communication device 106.

The communication device 106 can include hardware and/or software for generating and communicating signals over a direct and/or indirect network communication link. As used herein, a direct link can include a link between two devices where information is communicated from one device to the other without passing through an intermediary. For example, the direct link can include a Bluetooth™ connection, a Zigbee connection, a Wifi Direct™ connection, a near-field communications (“NFC”) connection, an infrared connection, a wired universal serial bus (“USB”) connection, an ethernet cable connection, a fiber-optic connection, a firewire connection, a microwire connection, and so forth. In another example, the direct link can include a cable on a bus network. An indirect link can include a link between two or more devices where data can pass through an intermediary, such as a router, before being received by an intended recipient of the data. For example, the indirect link can include a WiFi connection where data is passed through a WiFi router, a cellular network connection where data is passed through a cellular network router, a wired network connection where devices are interconnected through hubs and/or routers, and so forth. The cellular network connection can be implemented according to one or more cellular network standards, including the global system for mobile communications (“GSM”) standard, a code division multiple access (“CDMA”) standard such as the universal mobile telecommunications standard, an orthogonal frequency division multiple access (“OFDMA”) standard such as the long term evolution (“LTE”) standard, and so forth.

The sentry system 102 can communicate with one or more network resources via the network 116. The one or more network resources can include external databases, social media platforms, search engines, file servers, web servers, or any type of computerized resource that can communicate with the Sentry system 102 via the network 116.

As described above, the sentry system 102 can include hardware components to perform the processes described herein. In embodiments, one or more of components, hardware, and/or functionality of the sentry system 102 can be hosted and/or instantiated on a “cloud” or “cloud service.” As used herein, a “cloud” or “cloud service” can include a collection of computer resources that can be invoked to instantiate a virtual machine, application instance, process, data storage, or other resources for a limited or defined duration. The collection of resources supporting a cloud can include a set of computer hardware and software configured to deliver computing components needed to instantiate a virtual machine, application instance, process, data storage, or other resources. For example, one group of computer hardware and software can host and serve an operating system or components thereof to deliver to and instantiate a virtual machine. Another group of computer hardware and software can accept requests to host computing cycles or processor time, to supply a defined level of processing power for a virtual machine. A further group of computer hardware and software can host and serve applications to load on an instantiation of a virtual machine, such as an email client, a browser application, a messaging application, or other applications or software. Other types of computer hardware and software are possible.

In embodiments, the components and functionality of the sentry system 102 can be and/or include a “server” device. The term server can refer to functionality of a device and/or an application operating on a device. The server device can include a physical server, a virtual server, and/or cloud server. For example, the server device can include one or more bare-metal servers such as single-tenant servers or multiple-tenant servers. In another example, the server device can include a bare metal server partitioned into two or more virtual servers. The virtual servers can include separate operating systems and/or applications from each other. In yet another example, the server device can include a virtual server distributed on a cluster of networked physical servers. The virtual servers can include an operating system and/or one or more applications installed on the virtual server and distributed across the cluster of networked physical servers. In yet another example, the server device can include more than one virtual server distributed across a cluster of networked physical servers.

Various aspects of the systems described herein can be referred to as “information,” “content,” and/or “data.” Content and/or data can be used to refer generically to modes of storing and/or conveying information. Accordingly, data can refer to textual entries in a table of a database. Content and/or data can refer to alphanumeric characters stored in a database. Content and/or data can refer to machine-readable code. Content and/or data can refer to images. Content and/or data can refer to audio and/or video. Content and/or data can refer to, more broadly, a sequence of one or more symbols. The symbols can be binary. Content and/or data can refer to a machine state that is computer-readable. Content and/or data can refer to human-readable text.

Various of the devices in the sentry Environment 100, including the sentry system 102 and/or the user device 120 can provide I/O devices for outputting information in a format perceptible by a user and receiving input from the user. For example, the sentry system 102 can communicate with the I/O devices via the I/O interface 110. The I/O devices can display graphical user interfaces (“GUIs”) generated by the sentry system 102. The I/O devices can include a display screen such as a light-emitting diode (“LED”) display, an organic LED (“OLED”) display, an active-matrix OLED (“AMOLED”) display, a liquid crystal display (“LCD”), a thin-film transistor (“TFT”) LCD, a plasma display, a quantum dot (“QLED”) display, and so forth. The I/O devices can include an acoustic element such as a speaker, a microphone, and so forth. The I/O devices can include a button, a switch, a keyboard, a touch-sensitive surface, a touchscreen, a camera, a fingerprint scanner, and so forth. The touchscreen can include a resistive touchscreen, a capacitive touchscreen, and so forth.

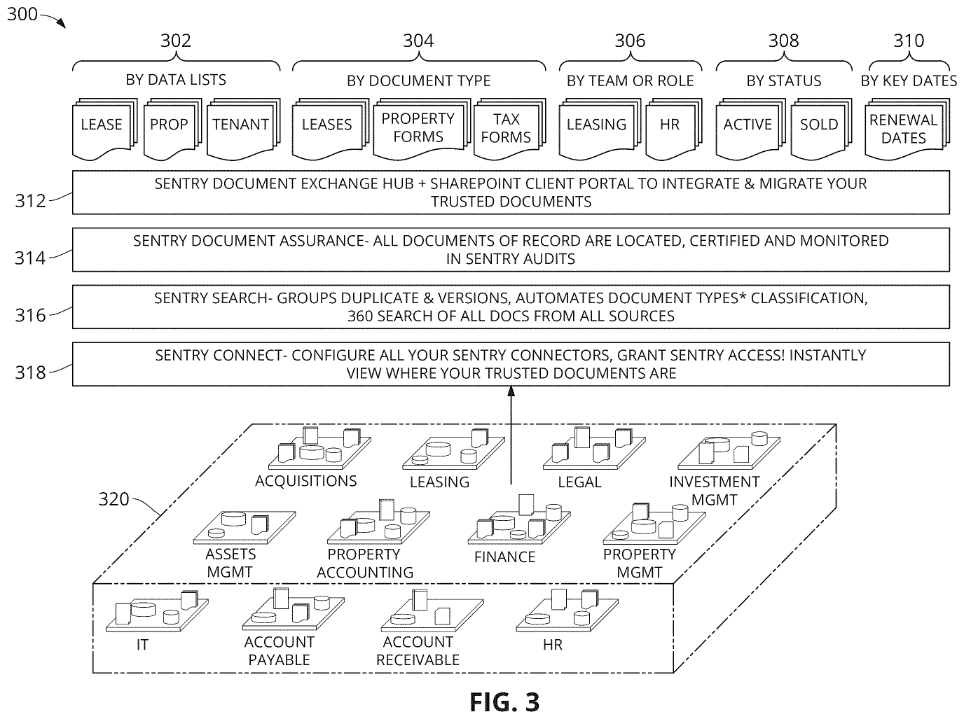

FIG. 2 illustrates method 200 for using a document management system, according to aspects of the present disclosure. While FIG. 2 illustrates various stages of the method 200, additional stages can be added, and existing stages can be removed and/or reordered.

Method 200 begins at step 202 where a user uploads at least one document to the document management system. In embodiments, the document management system is sentry system 102 and input interface module of sentry module 142 can be utilized to upload at least one document. In embodiments, input interface module is designed to be user-friendly and can support a variety of document formats.

For example, the sentry system 102 initiates the process by connecting to various document sources, such as cloud storage, file systems, email servers, or other data repositories, using native connectors. These connectors facilitate the secure transfer of document metadata and content to the sentry system 102 for processing without storing the actual documents.

At step 204, once at least one document is uploaded initial processing of the at least one document can occur. In embodiments, initial processing includes performing at least one validation of at least one document. In embodiments, validation can be performed by the document processing engine of sentry module 142 and can include file integrity and format validation checks. In embodiments, the sentry system 102 conducts a virus scan on the documents to ensure they are free from malware. If the document is an image or a scanned file, or contains embedded images, the system's Optical Character Recognition (OCR) capability is used to extract text from these images, preparing the document for further analysis.

The extracted text undergoes preprocessing, where common stopwords (e.g., “the,” “and,” “of”) are removed to reduce noise. The remaining text is then tokenized into smaller, meaningful segments that can be used in subsequent processing steps.

At step 206, once validation of at least one document is performed a unique identifier can be generated for the at least one document. In embodiments, the unique identifier can be generated by fingerprint generator of sentry module 142, and can be generated based on features present in at least one document.

The sentry system 102 generates a unique digital fingerprint for each document based on the tokenized text. The fingerprint is a compact representation of the document's key features, created using statistical methods such as CountVectorizer or TfidfVectorizer. The actual document content is never stored, ensuring security and privacy.

At step 208, at least one digital fingerprint can be stored. In embodiments, the unique identifier allows users to search for, retrieve, and manage documents based on their fingerprints. Additionally, dashboards and reporting tools can be provided that are configured to provide real-time updates and alerts about the compliance status of documents, aiding in proactive management; and generate reports detailing compliance status, document integrity, and other relevant metrics, which are crucial for audits and compliance reviews.

At step 210, at least one document can be classified utilizing the unique identifier. In embodiments, classification can be performed by document classification engine of sentry module 142. In embodiments, the document classification engine uses a digital fingerprint to categorize the document into a specific class based on predefined criteria. This might involve identifying the document type (e.g., legal contracts, financial statements) and associating it with relevant compliance requirements.

At step 212, once at least one document is classified, additional analysis can be performed on at least one classified document. In embodiments, analysis can be performed by data analysis module of sentry module 142. Analysis can include verification of document accuracy and relevance according to logical rules. In embodiments, analysis of at least one classified document checks the document for compliance with rules and standards. As a result of the analysis, any outliers can be flagged for review or remediation. The sentry system 102 analyzes the classified documents to verify their accuracy and compliance with regulatory standards. This step involves statistical comparisons and logical checks to ensure that each document meets the necessary criteria.

The sentry system 102 provides real-time monitoring of document compliance and integrity through a dashboard. Users can access reports and alerts that summarize the status of all documents within the system, aiding in proactive compliance management. The sentry system 102 API(s) allow integration with existing business systems, enabling seamless access to digital fingerprints and compliance reports without disrupting the organization's existing workflows.

As used in the description herein and throughout the claims that follow, “a”, “an”, and “the” include plural references unless the context clearly dictates otherwise. Also, as used in the description herein and throughout the claims that follow, the meaning of “in” includes “in” and “on” unless the context clearly dictates otherwise. While the above is a complete description of specific examples of the disclosure, additional examples are also possible. Thus, the above description should not be taken as limiting the scope of the disclosure which is defined by the appended claims along with their full scope of equivalents.

The foregoing disclosure encompasses multiple distinct examples with independent utility. While these examples have been disclosed in a particular form, the specific examples disclosed and illustrated above are not to be considered in a limiting sense as numerous variations are possible. The subject matter disclosed herein includes novel and non-obvious combinations and sub-combinations of the various elements, features, functions and/or properties disclosed above both explicitly and inherently. Where the disclosure or subsequently filed claims recite “a” element, “a first” element, or any such equivalent term, the disclosure or claims is to be understood to incorporate one or more such elements, neither requiring nor excluding two or more of such elements. As used herein regarding a list, “and” forms a group inclusive of all the listed elements. For example, an example described as including A, B, C, and D is an example that includes A, includes B, includes C, and also includes D. As used herein regarding a list, “or” forms a list of elements, any of which may be included. For example, an example described as including A, B, C, or D is an example that includes any of the elements A, B, C, and D. Unless otherwise stated, an example including a list of alternatively-inclusive elements does not preclude other examples that include various combinations of some or all of the alternatively-inclusive elements. An example described using a list of alternatively-inclusive elements includes at least one element of the listed elements. However, an example described using a list of alternatively-inclusive elements does not preclude another example that includes all of the listed elements. And, an example described using a list of alternatively-inclusive elements does not preclude another example that includes a combination of some of the listed elements. As used herein regarding a list, “and/or” forms a list of elements inclusive alone or in any combination. For example, an example described as including A, B, C, and/or D is an example that may include: A alone; A and B; A, B and C; A, B, C, and D; and so forth. The bounds of an “and/or” list are defined by the complete set of combinations and permutations for the list.

It should be understood, of course, that the foregoing relates to exemplary embodiments of the disclosure and that modifications can be made without departing from the spirit and scope of the disclosure as set forth in the following claims.

What is claimed is:

1. A method for document management, comprising:
receiving, in a document management system, a document, wherein the document is not permanently stored in the document management system;
Identifying if the document is an exact copy, (e.g. duplicate document) of an already processed document (e.g unique document), in which case the document doesn't need to be processed and fingerprinted again;
processing the document to identify metadata and contents of the document;
generating a digital fingerprint of the document based on the metadata and contents of the document;
storing the digital fingerprint in the document management system;
removing the document form the documents management system; and
Clustering and classifying the document based on the digital fingerprint and the metadata for the document.

2. The method of claim 1, the method further comprising:
analyzing the digital fingerprint to determine compliance with one or more rules.

3. The method of claim 1, wherein generating the digital fingerprint comprises:
performing statistical analysis on the content of the document to determine key features of the document.

4. The method of claim 1, wherein the classifying the document comprises:
classifying the document into one or more predetermined categories.

5. The method of claim 1, wherein the digital fingerprint is used in searches to identify any other similar documents in one search, including any other historical versions of the document, or sharing the same document type or class.

6. A computer-readable storage medium storing instructions that cause a processing device to perform a method for document management, the method comprising:
receiving, in a document management system, a document, wherein the document is not permanently stored in the document management system;
processing the document to identify metadata and contents of the document;
generating a digital fingerprint of the document based on the metadata and contents of the document;
storing the digital fingerprint in the document management system;
removing the document form the documents management system; and
classifying the document based on the digital fingerprint and the metadata for the document.

7. The computer-readable storage medium of claim 6, the method further comprising:
analyzing the digital fingerprint to determine compliance with one or more rules.

8. The computer-readable storage medium of claim 6, wherein generating the digital fingerprint comprises:
performing statistical analysis on the content of the document to determine key features of the document.

9. The computer-readable storage medium of claim 6, wherein the classifying the document comprises:
classifying the document into one or more predetermined categories.

10. The computer-readable storage medium of claim 6, wherein the digital fingerprint is used in searches to identify the document.
